(19) United States
(12) Patent Application Publication
(10) Pub. No.: US 2004/0262202 A1
(43) Pub. Date: Dec. 30, 2004

(54) System for producing packages of items of a predetermined collective weight

(75) Inventor: Sven Baekhoj Jensen, Ega (DK)

Correspondence Address: NIXON PEABODY, LLP, 401 9TH STREET, NW, SUITE 900, WASHINGTON, DC, 20004-2128, US

(73) Assignee: Scanvaegt International A/S, Aarhus (DK)

(21) Appl. No.: 10/819,353

(22) Filed: Apr. 7, 2004

Related U.S. Application Data
(60) Provisional application No. 60/461,124, filed on Apr. 9, 2003.

(51) Int. Cl. B65B 37/00; B07C 5/00

(52) U.S. Cl. 209/592; 209/652; 209/657; 209/630

(57) ABSTRACT

A system for collecting items is configured based on the realization that operators for manually moving the items from position bins to packing material can be positioned in only selected areas on both sides of the conveyor, with batch-forming areas being located on each side only at locations opposite the operator area on the opposite side. For instance, a first operator can serve the first two positions from a first side of the conveyor and a second operator can serve the following two positions from the second side of the conveyor and so on. This arrangement leaves free space, e.g., for packing material, for the second operator on the second side of the conveyor opposite the first operator's two positions.

### BACKGROUND OF THE INVENTION

1. Field of the Invention

The invention relates to a system for producing packages containing batches of items of a predetermined collective weight.

2. Description of Related Art

Grader type weighing machines are used for built up a number of packages - at a corresponding number of positions—in parallel. The items are weighed one by one and afterwards it is decided to which position each item is to be directed. The decision is based on historical data from previously weighed items and statistical rules. When a batch of items belonging to one package is completed at a position, the items are removed from there and the machine will begin the build-up of a new package at that position. The positions will finish batches of items in a random order.

The weighing machine is of the automatic type and is arranged with a conveyor belt. When the items are leaving the conveyor belt of the weighing machine they are transferred onto another conveyor belt. The positions are arranged as bins alongside this second conveyor belt and the items are removed from this conveyor belt by means of deflector wings arranged alongside the conveyor belt.

Normally there is one wing per position bin. However, in some cases, two separate batching positions are arranged in a single bin. In that case, the bin is equipped with a moveable split-plate. The placing of this split-plate will determine to which position an item will be transferred.

The deflector wings may be arranged on the opposite side of the conveyor from the position bins, such as known from U.S. Pat. No. 5,998,740 or they may be arranged on the same side as the position bins, such as known from U.S. Pat. No. 6,151,866. In some machines, the deflector wings are arranged on the opposite side from the position bins, where they are hinged in the end closest to the in-feeding end of the conveyor. They are turned when an item to be deflected into a position bin is passing by. In this case, there may be positions bins only on one side of the conveyor. If the deflector wings are arranged on the same side as the position bins, they are hinged at the downstream end, i.e., the end furthest from the in-feeding end of the conveyor. They are turned when an item to be deflected into a position bin is passing by. In this case, there may be deflector wings on both sides of the conveyor.

In some cases, two rows of items are arranged alongside each other and the weighing process is arranged so that the items running in the first row are weighed independently of the items running on the second row. In such cases, a conveyor with deflector wings hinged at the downstream end is preferred because such deflector wings can be arranged on both sides to remove items only from the row closest their respective side.

Furthermore, two conveyors can be arranged close to each other allowing them to share position bins arranged in the space between them. In such cases, items weighed on the first conveyor and items weighed on the second conveyor can be packed together in the same package (see, e.g. U.S. Pat. No. 6,151,866).

As it can be understood, various combinations can be arranged. For instance, the bins with split-plate can be used in combination with various conveyor configurations, and the “reverse” deflector wing can be used in combination with “centre” position bins as shown in U.S. Pat. No. 6,151,866.

All types of position bins can be equipped with one or more bottom gate(s) to increase the active operation time of that particular position. The advantage is easily acknowledged when considering the situation where several positions in front of a particular operator have finished their packages almost simultaneously. The operator needs time to move the items from the presentation tray to the packaging material. Therefore, the position(s) waiting to be attended to will be idle if not suitably accommodated. The bottom gate will provide a buffer feature and so the content for the second package can be assembled on top of the gate while the content for the first package is waiting in the presentation tray. If needed, several gates can be arranged on top of each other to expand the buffer capacity.

As it can be understood, worktables, finished package conveyor(s), presentation trays and bottom gates can be arranged together with various bin configurations. A special configuration comes into existence for the configuration with the center position bins. In this case, it is necessary to slide the presentation tray to the side of the item conveyor to get access to it. In some cases, it is built together with the bottom gate.

Along the side of the conveyor, workspaces are arranged. When a batch is completed in a position bin, the items in this bin are transferred to a worktable for manual processing, e.g., packing and/or trimming. An example of such apparatus is known from International Patent Application Publication WO 02/069772.

As shown in WO 02/069772, the manual processing may take place at both sides of the item conveyor. Hereby, a relatively compact layout may be achieved, i.e., a shorter item conveyor. However, in order to achieve a sufficient workspace for the operator, the workspaces along the sides of the conveyor must be of a certain size. This relation requires a certain length of the conveyor per workspace along the sides and limits the achievable compactness.

Quite often, the process of moving the items from the positions to the packing material has to be performed manually to present the items in the best possible way in the package. This applies, for instance, when packing chicken parts. Consequently, a worktable has to be provided and also quite often a presentation tray, e.g., for the items to be packed, underneath the position bin and a conveyor belt, e.g., to remove the finished packages from the operator workspace.

Despite these various configurations, it is often a problem to find the necessary space to move the items from the batching positions to the packages.

### SUMMARY OF THE INVENTION

Accordingly, it is an object of the present invention to provide a more efficient use of the space and to increase the capacity and functionality of a grader apparatus.

This invention is based on the realization that operators, for moving the items from the position bins to the packing material, can be positioned in only selected areas on both sides of the conveyor with batch-forming areas being located on each side only at locations opposite the operator area on the opposite side.

Accordingly, the invention relates to a system for collecting items, the system comprising: means for generating weight data for each said item, means for directing items to a plurality of positions arranged in at least one row where items are collected in accordance with said weight data to form, at each position, the content for a package with a weight falling within predetermined tolerances of a target weight, means for operators to manually facilitate the packing process located along said at least one row, and wherein a plurality of workspaces are provided for said operators on both of opposite sides of said at least one row, and at any given location along said at least one row, there being a workspace on only one side of said at least one row.

By the invention, the object is achieved, as there is made better use of the space on each side of the item conveyor means. For instance, a first operator can serve the first two positions from a first side of the conveyor and a second operator can serve the following two positions from the second side of the conveyor and so on. This arrangement leaves free space, e.g., for packing material, for the second operator on the second side of the conveyor opposite the first operator's two positions. The packing material can be conventional foam plastic trays held above the worktable in a tray dispensing bin.

This configuration works with virtually all of the previous shown conveyor and position combinations.

In a first embodiment, the means for directing items to a plurality of positions includes a two-lane item conveyor with deflector wings, and the positions are bins between said the two lanes. Furthermore, the means for manual operators to facilitate the packing process may include worktables arranged on outer sides of the said two-lane item conveyor.

In another embodiment, the means of directing items to a plurality of positions is a two-lane item conveyor with deflector wings, and the positions are bins arranged on each of outer sides of said two-lane item conveyor. Furthermore, the item conveyor may be a common conveyor for forwarding the items in two lanes.

Preferably, presentation trays are provided between the bins and the worktables to facilitate transfer of batches of items to the worktable. In a preferred embodiment, the trays are shiftable between a filling position, wherein the tray is filled with the items collected in a bin, and an emptying position, wherein the items in the tray is transferred onto the worktable. Hereby, the trays may also function as a bottom gate for the bins.

In another embodiment, the means for directing items to a plurality of positions includes a single row item conveyor with deflector wings on both sides, and the positions are bins on each side of the conveyor. Furthermore, the means for manual operators to facilitate the packing process preferably include worktables arranged on sides of the said item conveyor. Preferably, presentation trays are also provided between the bins and the worktables. Hereby, a compact apparatus may be provided making efficient use of the space.

In an embodiment of the invention, the position bins to which the items are directed are multi-compartment bins, which each contain at least two storage compartments in which items may be collected. This allows for an efficient use of the space available as the amount of bins in which packages are being built up can be doubled in number.

In one embodiment of the invention, the workspaces are provided adjacent to each bin. Items may be transferred to the workspace from one bin, either the bin adjacent to the workspace on the same side of the item conveyor or by the bin directly opposite the workspace on the other side of the conveyor. In an alternative embodiment, each of the workspaces is provided adjacent to two consecutively positioned bins. Hereby, it is made possible to provide the workspace with a plurality of types or sizes of items collected in two bins.

In one embodiment, the workspaces are alternately located on each side of the item conveyor. Thus, the workspaces are provided in a “zig-zag” configuration around the item conveyor. Hereby, the workspaces for the operators on each side are divided by a free space, e.g., occupied by equipment for supplying the workspace located on the opposite side with items, and/or storage space for packaging material.

In an alternative configuration, pairs of adjacent workspaces are alternately located on each side of the item conveyor, i.e., so that every workspace has a neighbouring workspace with free spaces on each side of these two workspaces.

In a preferred embodiment of the invention, at least one, but most preferably each workspace is provided means for holding a supply of empty packaging material. The “free space” beside the operator could advantageously be used for storage of packing material supply so that the packing trays are readily available for the operator.

Advantageously, packaging material conveyors are provided for supplying packaging material to the holding means at each workspace from at least one common packaging material supply storage. Hereby, the workspaces may be automatically provided with packaging material according to the actual packaging jobs that are being carried out. The packaging material may be supplied to the workspace holding means one by one or in small batches. Furthermore, different types of the packaging material may be supplied to the workspaces. In a preferred embodiment, the packaging material consists of stackable packaging trays. However, other types of packing material may also be supplied in this fashion.

In a further embodiment of the invention, at least two package conveyors are provided for transferring packages of items away from the workspaces for further processing. Hereby, the finished packages of items may be discharged from the apparatus onwards to further processing. The at least two package conveyors are provided on each side of the item conveyor for transferring the packages in opposite directions. This allows that the further processing equipment may be situated on both ends of the batching apparatus.

In order to increase the capacity of the apparatus, three package conveyors may be provided, and at least one of said three package conveyors is provided with a bend and said conveyor having a package receiving portion and a centrally transfer portion between the two other package conveyors. Hereby, three finished package outlets are provided, which also allows for a sorting of the finished packages according to their types and/or required further processing steps that they are to undertake. This sorting could be carried out automatically, if deflector means are provided in association with the package conveyors for sorting the packages onto a predetermined package conveyor according to a predetermined package characteristic.

In the following, the invention is described in further detail with reference to the accompanying drawings.

### BRIEF DESCRIPTION OF THE DRAWINGS

FIG. 1 is a schematic top view of a batching apparatus for batching out items according to a first embodiment;

FIG. 2 is a detailed view of a part of the batching section of the apparatus of FIG. 1;

FIG. 2a is a cross-sectional view taken along line A-A of FIG. 2;

FIGS. 3-6 are partial schematic views of other embodiments of a batching apparatus;

FIGS. 7-9 show schematic views of embodiments of details concerning item transferring in a batching apparatus;

FIG. 10 is a schematic principle view of a batching apparatus according to an embodiment of the invention;

FIG. 11 shows a principal view of another embodiment of the invention;

FIGS. 11a-d show principle cross-sectional views of the system shown in FIG. 11;

FIG. 12 is a principle view of one embodiment of the invention;

FIG. 13 is a principle view of a second embodiment of the invention;

FIGS. 14-16 are principle views of three embodiments of arrangements of package transfer conveyors in a batching apparatus according to the invention;

FIG. 17 is a top view of an embodiment of a batching apparatus according to the invention; and

FIGS. 18-24 show various detailed embodiments of the invention.

### DETAILED DESCRIPTION OF THE INVENTION

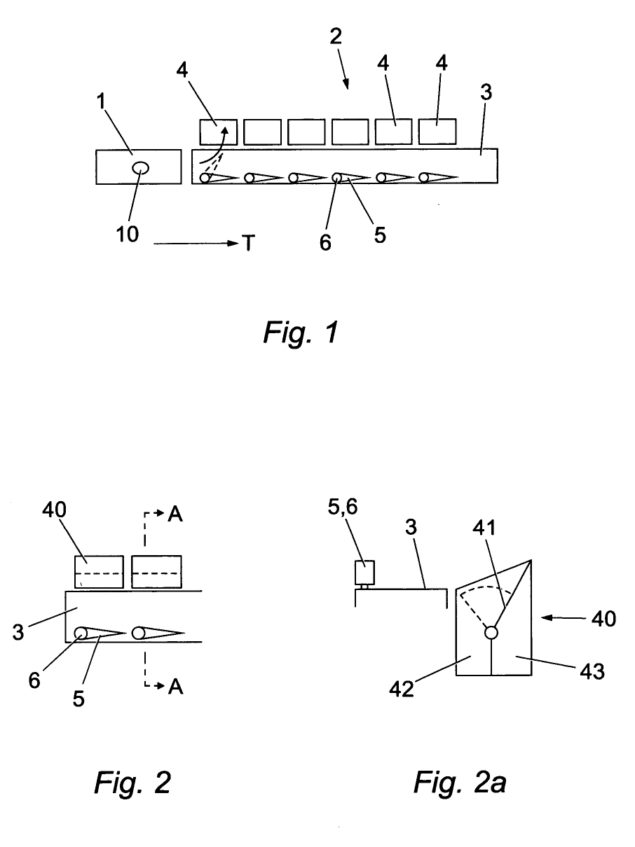

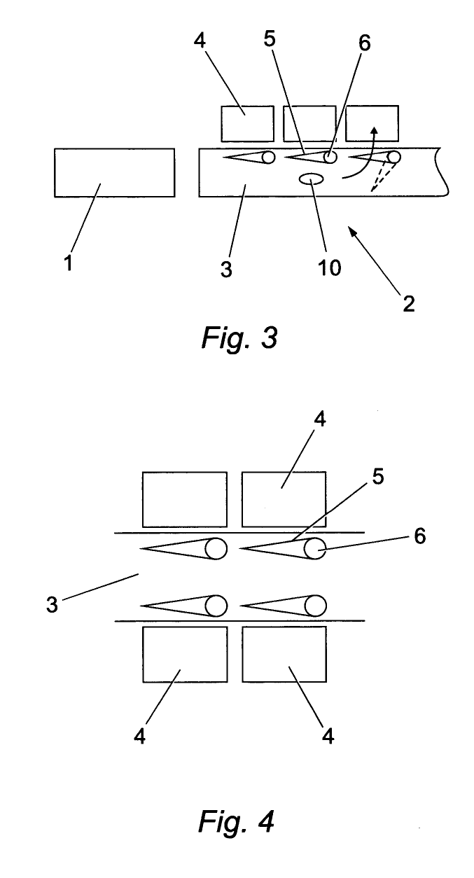

FIG. 1 shows a schematic view of a batching apparatus having weighing means 1 and a batching section 2. The weighing means 1 is generally of the automatic type and can be arranged in many ways, e.g. with one or more hopper scale(s) or a weighing device arranged with a conveyor belt. When the items or small groups of items are leaving the weighing means 1, they can be transferred onto a conveyor belt 3. The arrow T in FIG. 1 indicates the item transport direction. In some embodiments, a single belt can including the weighing. A number of packing bins 4 are arranged alongside this conveyor 3 and the items are removed from this conveyor 3 by means of deflector wings 5 or other deflection means arranged alongside the conveyor 3. Each deflector wing 5 is arranged in association with a bin 4. The deflector wings 5 are pivotably arranged on a hinge 6. Thus, the deflector wings 5 may be hinged “upstream”, as shown in, e.g., in FIG. 1, or “downstream” as shown in FIG. 3.

Of other deflection means, the following can be mentioned: pushers of various kinds or an air blast can be used, or the conveyor itself can be divided into a number of small conveyors each of which is able to tilt either longitudinal or transversal to remove the item (or the small of items) from the main stream. It can also be a number of bins underneath each other, each of which is proved with a bottom flip plate to direct the item(s) into the chosen next bin.

The apparatus is preferably provided with deflector wings 5, where there is normally one wing 5 per position bin 4. In some cases, two positions are arranged in one bin 40, as shown in FIG. 2 and FIG. 2a. In that case, the bin 40 is equipped with a moveable split-plate 41. The placing of this split-plate 41 will determine which position an item will be transferred to, i.e., if the item is transferred to the first compartment 42 or the second compartment 43 of the split bin 40 (see FIG. 2a).

In one embodiment, the deflector wings 5 may be arranged on the opposite side of the conveyor as the position bins, as shown in FIG. 1, or in another embodiment, they may be arranged on the same side as the position bins, as shown in FIG. 3.

If the deflector wings 5 are arranged on the opposite side from the position bins, they are hinged at the end closest to the in-feeding end of the conveyor. They are turned when an item 10 (or a little group of items) that is passing by is to be deflected into a position bin. In this case, there may be positions bins only on one side of the conveyor (FIG. 1).

If the deflector wings 5 are arranged on the same side as the position bins 4, they are hinged at the downstream end, i.e., the end furthest from the in-feeding end of the conveyor (FIG. 3). They are turned when an item 10 (or a little group of items) to be deflected into a position bin 4 is passing by. In this case, there may be deflector wings 5 on both sides of the conveyor 3 as shown in FIG. 4.

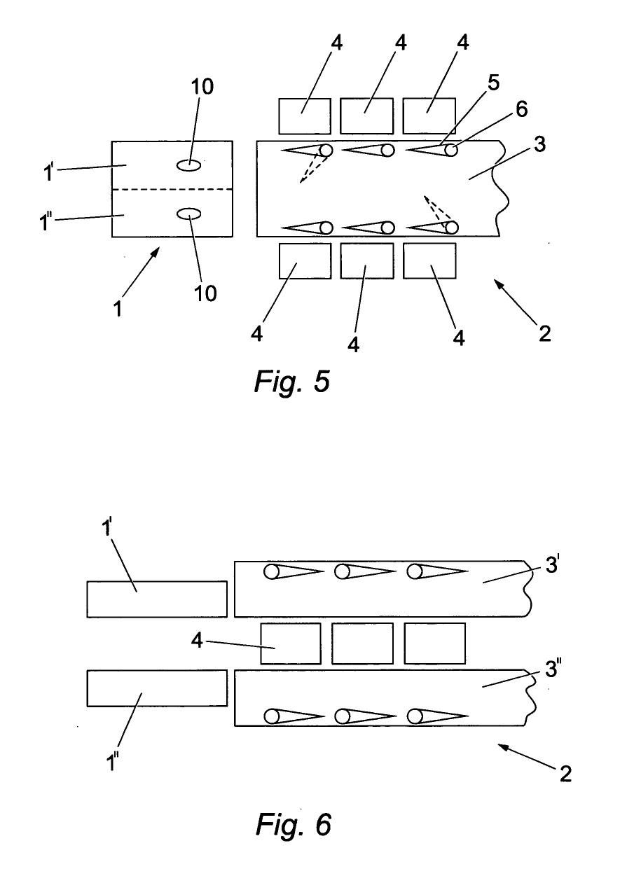

In another embodiment (FIG. 5), two rows of items 10 are arranged alongside each other and the weighing process is arranged so that the items 10 running in the first row 1′ are weighed independently of the items 10 running on the second row 1″. In this embodiment, a conveyor 3 with deflector wings 5 hinged in the end opposite the feeding end is preferred because such deflector wings 5 can be arranged on both sides to move items 10 only from the closest row.

As shown in FIG. 6, two conveyors 3′, 3″ can be arranged close to each other allowing them to share position bins 4 arranged in the space between them. In such cases, items weighed in a weighing apparatus 1′ arranged in association with the first conveyor 3 and items weighed in a weighing apparatus 1″ arranged in association with the second conveyor 3″ can be packed together in the same package.

As it can be understood from the figures, various combinations can be arranged. For instance, the bins 40 with split-plate 41 (see FIG. 2) can be used in combination with the apparatus shown in any of FIGS. 3, 4 and 5, and the downstream deflector wing 5 (see FIG. 3) can be used in combination with “center” position bins 4 (see FIG. 6).

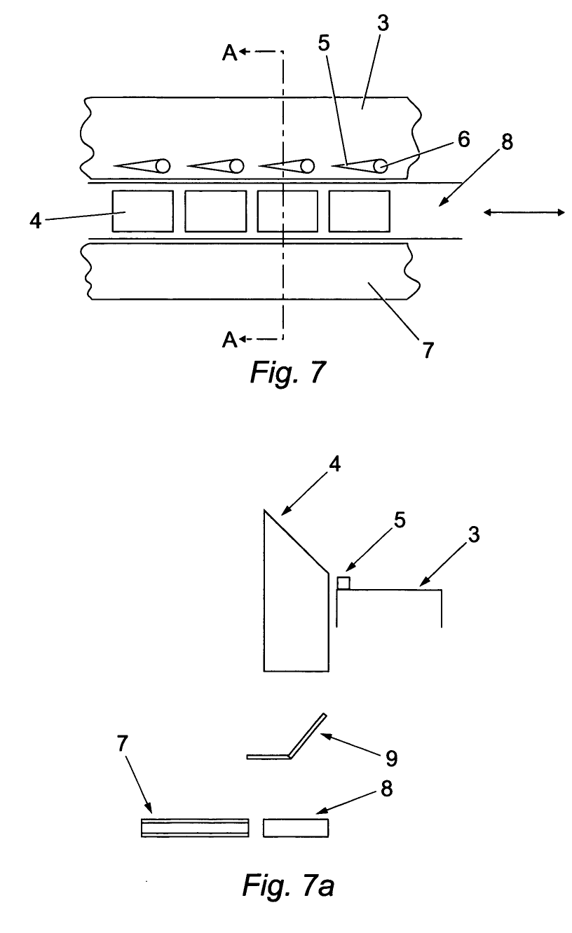

Quite often, the process of moving the items from the positions to the packing material has to be done manually to present the items in the best possible way in the package. This applies for instance when packing chicken parts. Consequently, a worktable 7 has to be provided and also quite often a presentation tray 9 for the items be packed, underneath the position bin 4 and at least one conveyor belt 8 to remove the finished packages from the operator workspace 12 (see, FIG. 7).

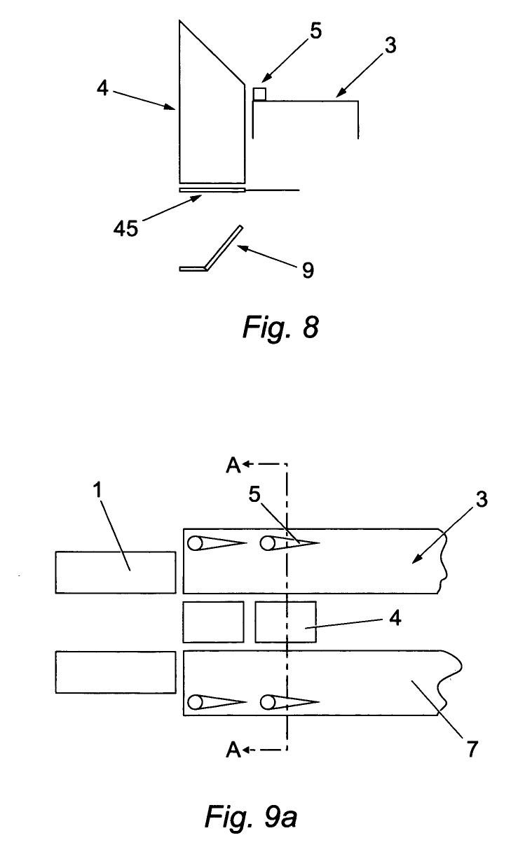

All types of position bins 4 can be equipped with one or more bottom gate(s) 45 to increase the active operation time of that particular position. The advantage is easily acknowledged when considering the situation where several positions in front of a particular operator have finished their packages almost simultaneously. The operator needs time to move the items from the presentation tray 9 to the packaging material. Therefore, the position(s) waiting to be attended to will be idle if not suitably accommodated. The bottom gate 45 will provide a buffer feature and so the content for the second package can be assembled on top of the gate while the content for the first package is waiting in the presentation tray 9 (see, FIG. 8). If needed, several gates can be arranged one above another to expand the buffer capacity.

If the items are not moved from the position bins 4 to the packing material at the place of the position bins 4, a so-called takeaway conveyor 8 can be installed underneath the position bins 4. This conveyor 8 transfers the packages of items to a remote place where they are moved from the conveyor belt 8 to the further processing either automatically or manually. In such cases, the position bins 4 have to be equipped with at least one level of buffer (as described above) to enable the positions bins 4 to hold the items until all the items to form a package are collected. When all the items are collected, the items are released from the position bin 4 at an empty spot on the takeaway conveyor belt 8. A controller will keep track of the items on the conveyor belt 8 so the items belonging to another package will not be released at the same spot on the belt—this to avoid mixing items belonging to various packages.

The items may alternatively be collected directly from the deflector wings in wheeled containers placed alongside the conveyor.

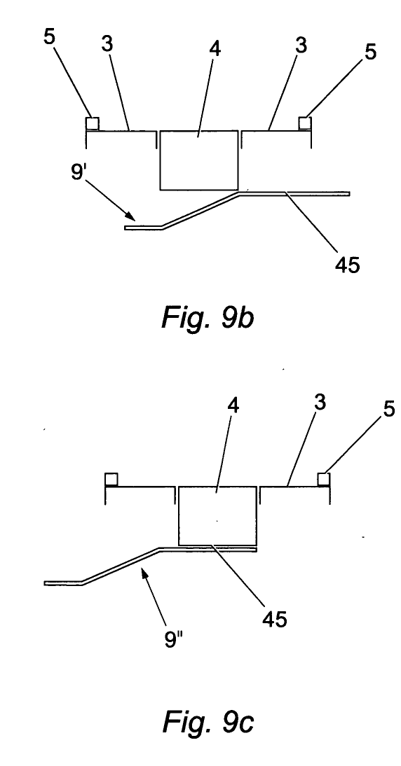

1 As it can be understood from the figures, worktables 7, finished package conveyor(s), presentation trays 9 and bottom gates 45 can be arranged together with various bin configurations. A special configuration comes into existence for the configuration with the center position bins 4. In this case, it is necessary to slide the presentation tray 9 to the side of the item conveyor 3 to get access to it. In some cases, it is built together with the bottom gate (see, e.g., FIGS. 9, 9a and 9b).

Despite these various configurations, it is often a problem to find the necessary space to move the items from the batching positions to the packages.

A preferred embodiment is one with centrally positioned batch-forming bins 4 and a combined presentation tray 9 having integrated bottom gates 45. In this configuration, the operators can be working within a relatively small physical area because they are fed with an adequate number of items at a relatively low number of positions. This gives a high throughput at a relatively low operator stress level. Simultaneously, the configuration is highly space saving. The empty packing material can be placed on the worktable from the dispensing bins 50.

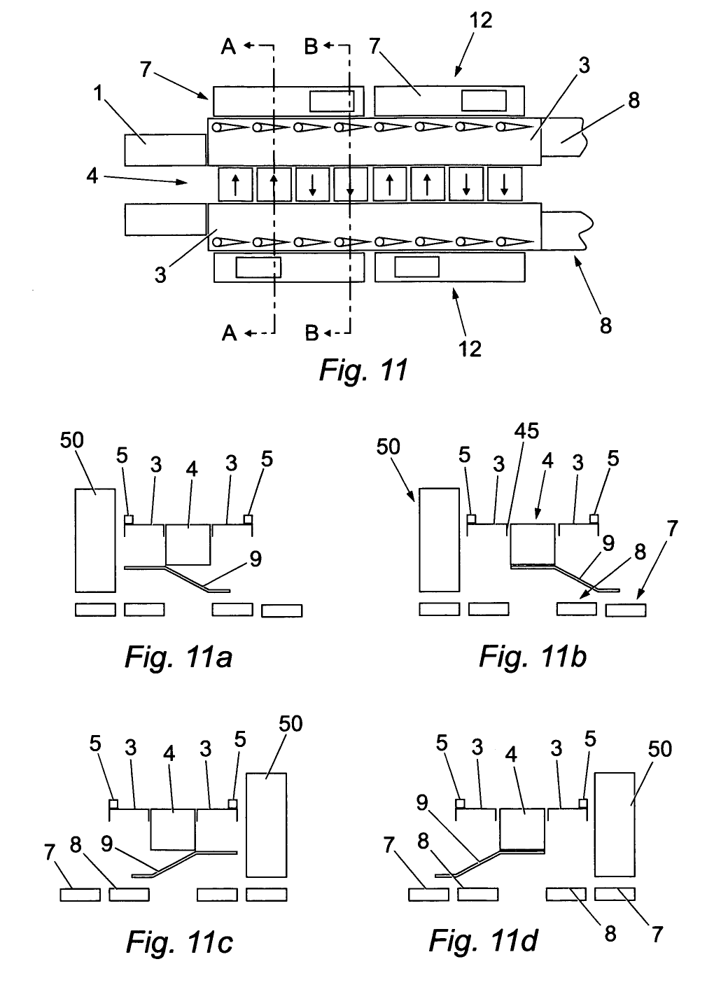

1 In FIG. 11, the arrows in the central batch-forming bins indicate the operator toward whom the completed batches are directed. Sections A-A₁ and A-A₂ (shown in FIGS. 11a and 11b, respectively) are views showing the first operator's workstation while sections B-B, and B-B₂ (FIGS. 11c and 11d, respectively) show the second operator's workstation 12. In the views of sections A-A₁ and B-B₁, the presentation trays 9 are retracted, opening the bottom of the bins 4 so that batches formed therein can travel out onto the presentation tray 9 which can then be shifted into the positions of sections A-A₂ and B-B₂ in which the items on the presentation tray 9 are brought within reach of the operator while simultaneously closing the bottom of the bin 4 for enabling a new batch to be formed in the bin 4 while the operator handles the batch presented for packaging.

As is also apparent from the views of FIG. 11 and FIGS. 11a-d, even though the batch-forming bins 4 for both operators are centrally located, their presentation trays 9 extend to opposite sides of the processing line. Thus, space is provided for the packaging material supplies 50 at those locations were the presentation trays 9 are directed toward the operator workstation 12 at the opposite side of the batch-forming bins 4.

Other embodiments are also possible. For example, the two-row configuration of FIG. 5 can be equipped with funnels or transversal conveyors below the item conveyor to collect items from both sides centrally or at one side in a common position. The remaining functions can then be carried out in the same way as in the preferred embodiment.

Also all the one-row configurations can be equipped with worktables on both sides of the conveyor giving the same basic advantage.

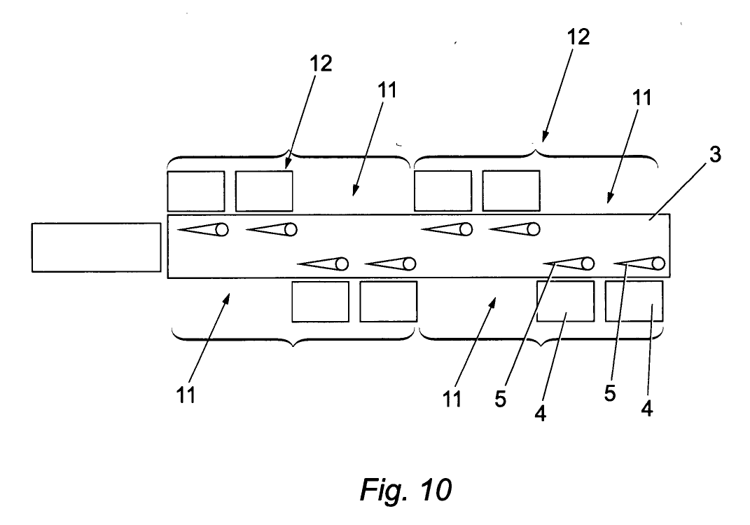

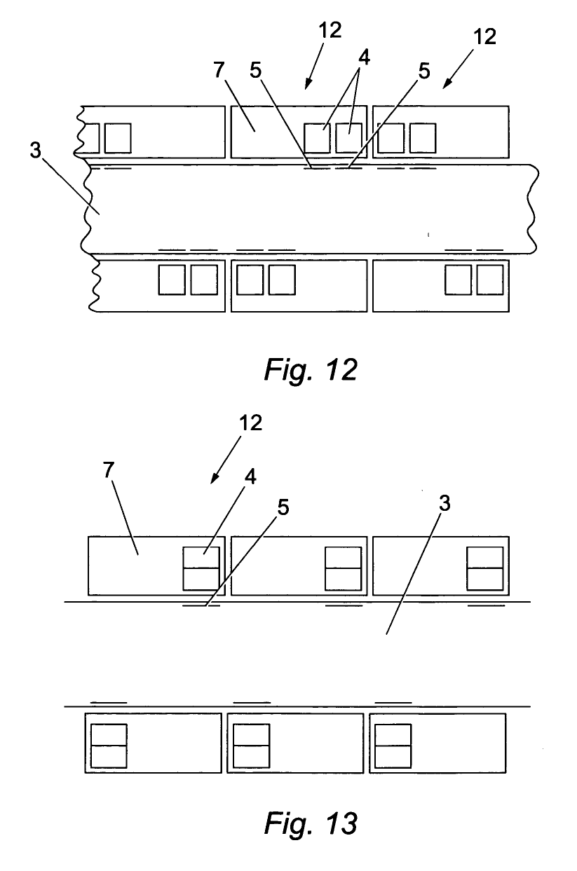

As shown in FIG. 10 and FIGS. 12 to 24, the workspaces 12 are located along the item conveyor arrangement 3 (one or two rows) on both sides in such a way that a free space is directly opposite each of the workspaces 12. As shown in FIGS. 12 and 13, the operators' workspaces 12 may be arranged either “two by two” (FIG. 12), where the workspaces along each side are shiftably arranged on the right-hand side and the left-hand side of the worktables 7. Each workspace 12 is fed with batches of items from two bins 4, in which batches are being built up of items deflected by the deflector wings 5 from the item conveyor 3. In another embodiment, the workspaces 12 are all designed with the same layout, as shown in FIG. 13, where the workspaces alter “one-by-one” along the sides of the conveyor 3.

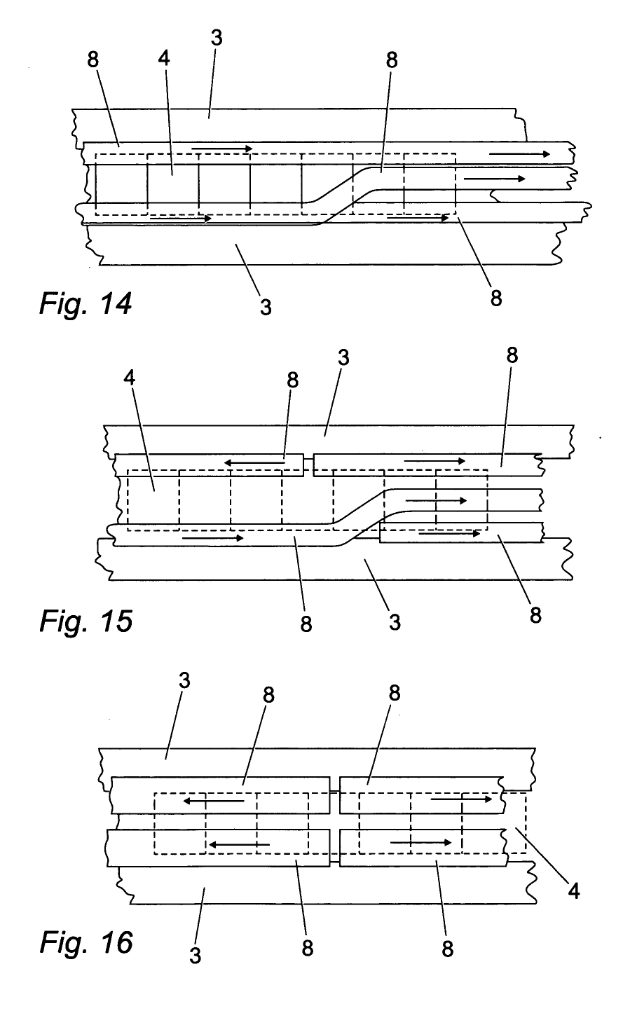

As explained above, take-away conveyors 8 are preferably provided for transferring the finished packages from the workspaces 12 to further treatment elsewhere. In the FIGS. 14 to 16, different configurations of the take-away package conveyors 8 are shown. In FIG. 14, a configuration with three package conveyors 8 is shown. The finished packages may be, e.g., sorted by sorting means (not shown) depending on type or size and moved onto a particular take-away conveyor 8 for further treatment. In FIGS. 15 & 16, two configurations are shown where the packages are taken away in different directions, e.g. dependent on type or size of the packages.

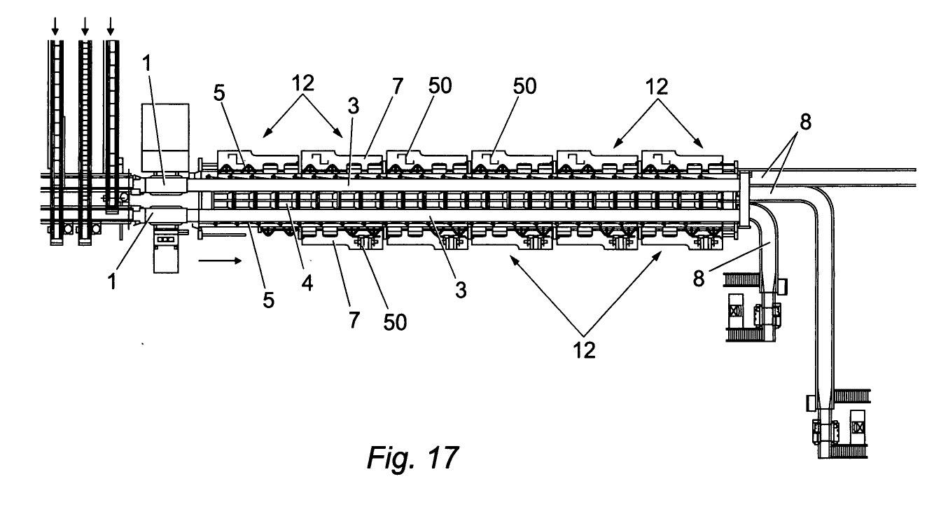

In FIG. 17, a preferred embodiment of the batching and packing system according to the invention is shown. Items are supplied to the batching apparatus in two rows over weighting devices 1 and onwards to two items conveyors 3 where position bins 4 are provided between the two item conveyors 3. Items are deflected into the bins 4 by the deflector wings 5 arranged along each side of the item conveyor arrangement. The workspaces 12 on each outer side of the item conveyors 3 include a worktable 7 and a packaging material supply 50 beside the workspace for the operator at the “free” space 11 (see also FIG. 10) where an operator is placed on the opposite side of the item conveyor arrangement. At the workspaces, the batches of items built up in the bins 4 are transferred to the worktables where the items are manually processed and packed. The finished packages of items are placed on the take-away conveyors 8 and transferred onwards for further treatment.

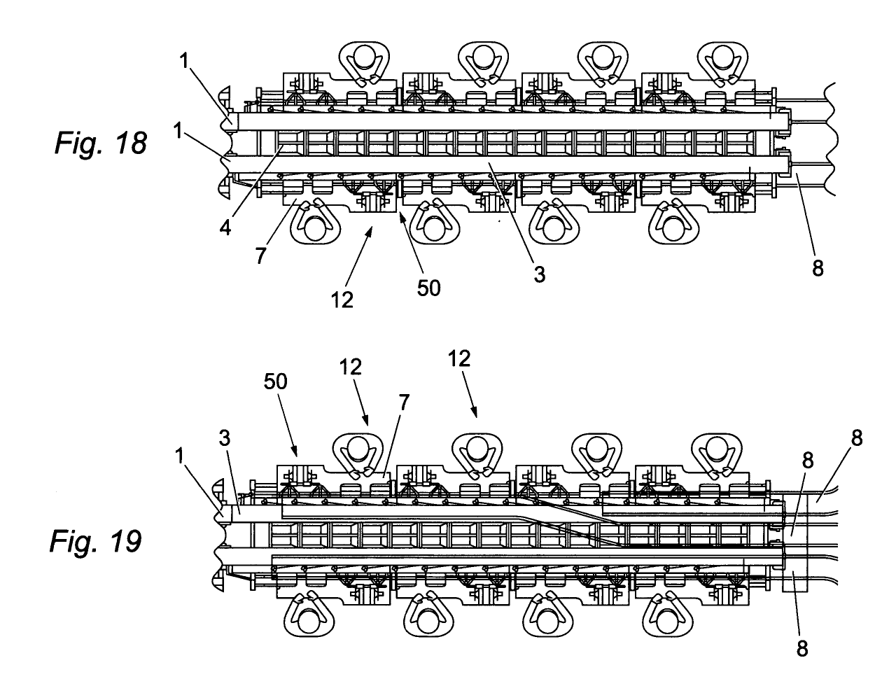

The batching system may be configured in different ways depending on the type of functions demanded by the food processing industry. In FIGS. 18 to 24, several configurations are shown. FIG. 18 show a section of the item conveyor arrangement of FIG. 17 with two take-away conveyors 8 arranged for transferring finished packages from the workspaces 12 at each side of the item conveyors 3. The take-away conveyors 8 are positioned below the item conveyors 3. In FIG. 19, however, the take away conveyors are shown. In this configuration, three take-away conveyors 8 are arranged for transferring finished packages from the workspaces 12. One is provided with a bend so that it collects the packages from some operators and a second conveyor 8 collects for the next section of workspaces at the same side.

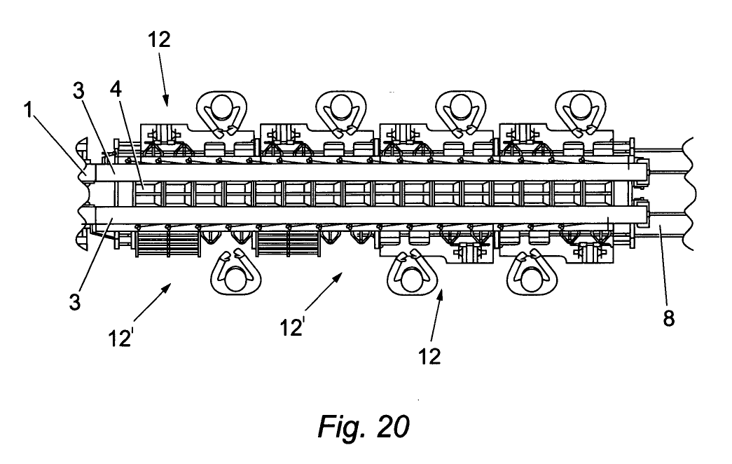

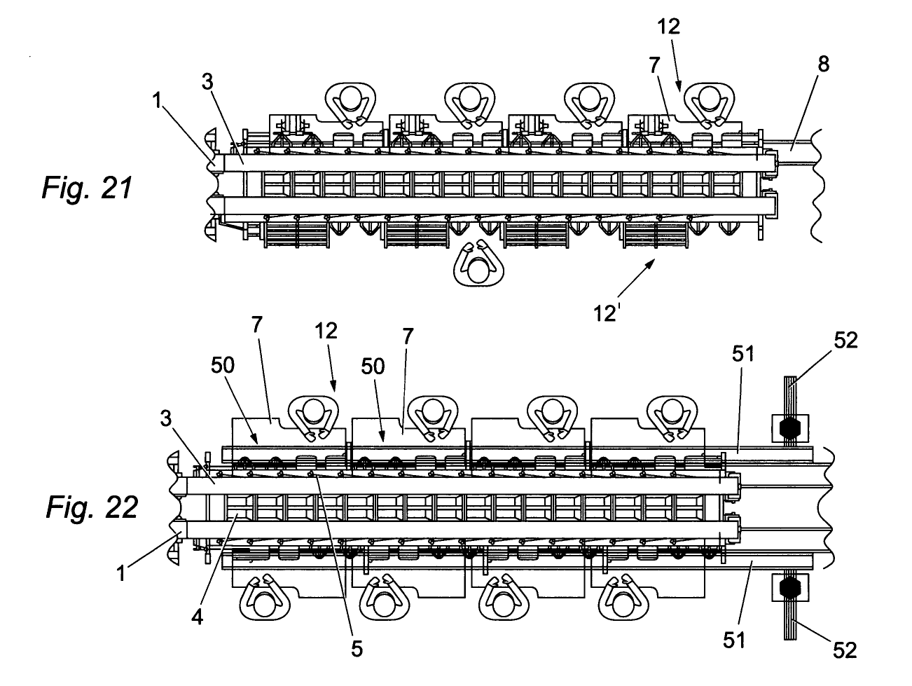

As shown in FIG. 20, several types of the workspaces 12, 12′ may be provided along the item conveyor arrangement. A second type of workspace 12′ may be provided either at some locations on one side of the item conveyor arrangement 3 (FIG. 20) or that locations along one side are the same and are different from the workspaces 12 on the other side (FIG. 21).

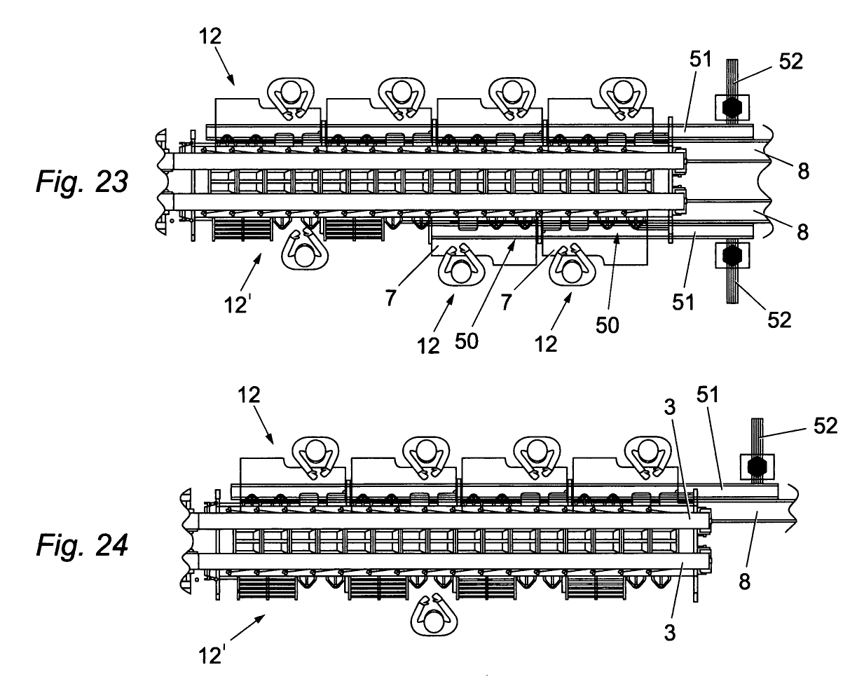

In FIGS. 22 to 24, different configurations of the packaging material supply 50 in the batching system are shown. In FIG. 22, packaging material supply 50 at each workspace is provided, where a packaging material conveyor 51 supplies each workspace with packaging material from a common storage 52. A supply line 51, 52 is provided at each side of the item conveyor arrangement. As shown in FIGS. 23 and 24, the supply line may be terminated so that only workspaces 12 having a need for being supplied with packaging material is connected to the automatic packaging supply system, whereas workspaces 12′ of a different kind may be disconnected from this system.

The invention is described above with reference to some preferred embodiments. However, it is realized that many other variants and equivalents may be designed without departing from the scope of the invention as defined in the accompanying claims.

What is claimed is:

1. A system for collecting items, the system comprising:
means for generating weight data for each said item,
means for directing items to a plurality of positions arranged in at least one row where items are collected in accordance with said weight data to form, at each position, the content for a package with a weight falling within predetermined tolerances of a target weight,
means for operators to manually facilitate the packing process located along said at least one row, and
wherein a plurality of workspaces are provided for said operators on both of opposite sides of said at least one row, and at any given location along said at least one row, there being a workspace on only one side of said at least one row.

2. A system according to claim 1, wherein the means for directing items to a plurality of positions includes a two-lane item conveyor with deflector wings, and the positions are bins between said the two lanes.

3. A system according to claim 2, wherein the means for operators to manually facilitate the packing process include worktables arranged on outer sides of the said two-lane item conveyor.

4. A system according to claim 3, wherein presentation trays are provided between the bins and the worktables.

5. A system according to claim 4, wherein said trays are shiftable between a filling position, wherein the tray is positioned to receive items collected in a respective one of the bins, and an emptying position, wherein the items received in the tray are transferred onto the worktable.

6. A system according to claim 1, wherein the means of directing items to a plurality of positions is a two-lane item conveyor with deflector wings, and the positions are bins arranged on each of outer sides of said two-lane item conveyor.

7. A system according to claim 6, wherein the item conveyor is a single conveyor for forwarding the items in two lanes.

8. A system according to claim 6, wherein the means for operators to manually facilitate the packing process include worktables arranged on outer sides of the said two-lane item conveyor.

9. A system according to claim 8, wherein presentation trays are provided between the bins and the worktables.

10. A system according to claim 1, wherein the means for directing items to a plurality of positions includes a single row item conveyor with deflector wings on both sides, and the positions are bins on each side of the conveyor.

11. A system according to claim 10, wherein the means for operators manually to facilitate the packing process include worktables arranged on sides of the said item conveyor.

12. A system according to claim 11, wherein presentation trays are provided between the bins and the worktables.

13. A system according to claim 1, wherein the position bins to which the items are directed are multi-compartment bins that contain at least two storage compartments in which items may be collected.

14. A system according to claim 1, wherein the workspaces are provided adjacent to each bin.

15. A system according to claim 1, wherein each of the workspaces are provided adjacent to two consecutively positioned bins.

16. A system according to claim 1, wherein the workspaces are alternately located on each side of the item conveyor.

17. A system according to claim 1, wherein pairs of adjacent workspaces are alternately located on each side of the item conveyor.

18. A system according to claim 1, wherein each workspace comprises means for holding a supply of empty packaging material.

19. A system according to claim 18, wherein packaging material conveyors are provided for supplying packaging material to the holding means at each workspace from at least one common packaging material supply storage.

20. A system according to claim 18, wherein the packaging material is supplied to the workspace holding means one by one.

21. A system according to claim 18, wherein the packaging material is supplied to the workspace holding means in small batches.

22. A system according to claim 18, wherein different types of the packaging material are supplied to the workspaces.

23. A system according to claim 18, wherein said packaging material is stackable packaging trays.

24. A system according to claim 1, wherein at least two package conveyors are provided for transferring packages of items away from the workspaces for further processing.

25. A system according to claim 24, wherein at least two package conveyors are provided on each side of the item conveyor for transferring the packages in opposite directions.

26. A system according to claims 24, wherein three package conveyors are provided, and at least one of said three package conveyors is provided with a bend and said one of the conveyors having a package receiving portion and a centrally transfer portion between the two other package conveyors.

27. A system according to claim 24, wherein deflector means are provided in association with the package conveyors for sorting the packages onto a predetermined one of the package conveyors according to a predetermined package characteristic.
